(19) United States
(12) Patent Application Publication
(10) Pub. No.: US 2026/0227268 A1
(43) Pub. Date: Aug. 6, 2026

(54) Acoustic-Thermal Method and Device for Determining Leakiness in a Building Envelope

(71) Applicant: Deutsches Zentrum fur Luft- und Raumfahrt e.V., Bonn (DE)

(72) Inventors: Benedikt Kölsch, Wuppertal (DE); Björn Schiricke, Köln (DE)

(21) Appl. No.: 19/147,386

(22) PCT Filed: Jan. 3, 2024
(86) PCT No.: PCT/EP2024/050092

§ 371 Date: Jul. 11, 2025

(30) Foreign Application Priority Data
Jan. 13, 2023 (DE) 10 2023 100 701.7

(51) Int. Cl. G01M 3/24; G01M 3/00

(52) U.S. Cl. CPC G01M 3/24; G01M 3/002

(57) ABSTRACT

A method for determining leakiness in a building envelope of a building, including the steps of generating a sound signal, acquiring a thermography image of at least a part of the building envelope, acquiring an acoustic image of the same part of the building envelope, and superimposing the thermography image and the acoustic image to determine the leakiness of the building envelope.

### CROSS-REFERENCE TO RELATED APPLICATIONS

This application is the United States national phase of International Patent Application No. PCT/EP 2024/050092 filed Jan. 3, 2024, and claims priority to German Patent Application No. 10 2023 100 701.7 filed Jan. 13, 2023, the disclosures of which are hereby incorporated by reference in their entireties.

### BACKGROUND OF THE INVENTION

### Field of the Invention

The present invention relates to a method for determining leakiness in a building envelope of a building. Furthermore, the present invention relates to a device for carrying out the method.

### Description of Related Art

The most commonly used measurement technique for assessing the airtightness of a building is the pressure difference measurement method (known as the “blower door test”). This measurement method is used to measure the airtightness of buildings in order to meet the requirements of energy standards, to compare the airtightness of different buildings or to determine the reduction in air permeability after renovation measures. However, this method only determines the integral air exchange rate of a room or building. Since identifying leakage points and prioritizing the sealing of larger leaks increases the airtightness of buildings, quick and easy localization is highly relevant. Leaks can currently be identified using smoke sticks or anemometers in conjunction with a blower door test or trace gases, for example. However, these methods are very complex and time-consuming.

Infrared thermography (IR thermography) is a non-contact, non-destructive and standardized (DIN EN 13187:1998) measurement method for displaying temperatures of building surfaces and thus enabling the visualization of leaks and thermal bridges in the building envelope. The surface temperatures in the vicinity of leaks are significantly influenced by the air flow through this opening and therefore allow easy identification of this leakiness. However, a significant pressure difference, in addition to a temperature difference (min. 10° C.), is usually required to distinguish leaks from thermal bridges beyond doubt. This so-called differential thermography also takes about half an hour per measurement.

### SUMMARY OF THE INVENTION

The object of the present invention is to provide a method and a device for improved detection of leakiness in a building envelope.

The object is achieved with a method and a device as described herein.

Methods according to the invention for determining leakiness in a building envelope of a building comprise the following steps:
generating a sound signal,
acquiring a thermography image of at least a part of the building envelope;
acquiring an acoustic image of the same part of the building envelope by spatially resolved detection of the sound signal; and
superimposing the thermography image and the acoustic image to locate the leakiness of the building envelope.

The building envelope is, for example, the outer walls, glazing, roof or any other structural elements that separate the interior of the building from the surroundings. A sound signal is then generated inside the building. A thermography image is created of at least a part of the building envelope from the outside. An acoustic image is also created of the same part of the building envelope. Here, the part of the building envelope for which the thermography image was created and the part of the building envelope for which the acoustic image was acquired overlap at least partially.

The method is based on locating noises or the generated sound signal that propagate through leaks in the building envelope. One way of locating sound sources is so-called beamforming. In general, beamforming is a signal processing technique that allows an array of microphones to distinguish sound sources from different directions. The measuring principle is based on the microphone array targeting different measuring points on a measurement object. During evaluation, the time signals of the individual microphones of the array are superimposed with a time delay that corresponds to the time it takes for the sound wave to travel from the measured focus point to the microphone. These time-corrected signals from all microphones are added together, resulting in a time signal assigned to the respective focus point. If the origin of a noise component is located at this point, this results in positive interference for all microphone signals after the corresponding time shift and thus a maximum signal value. However, if the viewing angle does not match the angle of incidence of the sound waves, the signals are partially canceled out. Noise sources outside the focus direction of the acoustic camera are therefore reduced.

The method is also called “acoustic camera” because the result of a sampling process over a range of viewing angles produces an image of the most intense constructive interferences of the acoustic waves. The advantage for a plurality of applications is the visual result, which can be superimposed with a visible image of the same scene. Such an acoustic camera is known from WO2013/024926 A1, for example.

The thermography image and the acoustic image are then superimposed to determine the leakiness of the building envelope. By superimposing the thermography image and the acoustic image, the information from the thermography image and the acoustic image is combined and can thus increase the accuracy for determining the leakiness of the building envelope. Sources of error in the creation of the thermography image do not affect the creation of the acoustic image. Likewise, errors in the creation of the acoustic image do not affect the acquisition of the thermography image. For example, an external sound source, which would lead to errors when creating the acoustic image, has no influence on the acquisition of the thermography image. This means that leakiness in the building envelope can be determined with a high degree of accuracy by superimposing the acquired information. In doing so, the thermography image may show temperature differences, for example. Furthermore, the acoustic image can include spatially resolved acoustic amplitudes. Preferably, the thermography image and the acoustic image can be superimposed, for example by maximum/minimum value selection of the amplitudes of the acoustic image or the temperature differences of the thermography image.

Even if it is described above that in the method the sound signal is generated inside the building and the thermography image and the acoustic image are captured from outside, this can of course also be reversed so that the sound signal is generated outside the building and both the thermography image and the acoustic image are recorded and acquired from inside the building. However, it has proven to be advantageous to acquire the thermography image from the outside, as a larger area can be acquired at the same time.

Preferably, the thermography image is acquired before the acoustic image. Alternatively, the thermography image is acquired after the acoustic image. Alternatively, the thermographic image and the acoustic image are acquired simultaneously.

Preferably, the entire part of the building envelope is captured by means of a thermography image and/or an acoustic image. Alternatively, only sides or parts of a side of a building can be recorded using a thermography image and an acoustic image, with a separate thermography image and acoustic image being acquired for each side of the building, for example.

Preferably, the acoustic image and/or the thermography image is superimposed with a visible image of the same scene or the same part of the building envelope. Alternatively or additionally, the result from the superimposition of the thermography image and the acoustic image is superimposed with a visible image of the same scene or, for example, the overlap between the thermography image and the acoustic image. This makes it easy to visually localize leakiness in the building envelope.

Preferably, the thermography image and the acoustic image are acquired from the same location. This ensures that the alignment of the thermography image and the acoustic image match and, in particular, that no distortion has to be considered when superimposing the thermography image and the acoustic image.

The acoustic image is preferably acquired at different frequencies. In this way, different propagation characteristics of the generated sound signal can be considered. Interfering noise at certain frequencies can also be suppressed or absent at other frequencies and therefore no longer influence the creation of an acoustic image.

Preferably, the acoustic images are superimposed at different frequencies, for example by averaging or maximum/minimum value selection. Alternatively, one or more acoustic images can be selected, as long as they are not disturbed by interfering noise and/or allow a clear localization of the sound signal.

Preferably, the acoustic images are recorded in a frequency range between 20 Hz and 100 kHz. Acoustic images in a range between 400 Hz and 40 kHz are particularly preferred.

Preferably, the sound signal is generated once, periodically or continuously.

Preferably, the sound signal is noise and in particular white noise in the specified frequency range.

Preferably, one or more loudspeakers are positioned inside or outside the building to generate the sound signal. The loudspeaker can be a dodecahedron loudspeaker or an omnidirectional loudspeaker, for example, so that the sound signal is generated as evenly as possible in all directions within the building.

Preferably, a positive or negative pressure is created in the building to generate the sound signal. The positive or negative pressure causes air to flow that passes through the leakiness in the building envelope. The sound signal generated by the flowing air can be used to detect leakiness. At the same time, the temperature difference is increased, for example by warm air flowing out of the building into the colder environment or vice versa, so that the signal of the thermography image and in particular the differential temperature detected by the thermography image is further increased.

Furthermore, the method is carried out with a device as described below.

Further, the present invention relates to a device for acquiring a thermography image and an acoustic image for determining leakiness in a building envelope. The device has a thermography camera and a microphone array with a plurality of microphones. The microphones are arranged at a fixed distance from one another and preferably at a fixed distance relative to the thermography camera. The acoustic image is acquired by means of the microphone array. The device therefore has a combined option for acquiring the thermography image and the acoustic image. Due to the fixed relative position between the microphone array and the thermography camera, it is particularly easy to superimpose the thermography image and the acoustic image. Unintentional offset and/or distortion of the thermography image and the acoustic image when superimposed, which would lead to inaccuracies in the detection of leakiness, can be minimized or corrected. Only calibration is required before using the device for the first time.

Preferably, the thermography camera is arranged in the center or substantially in the center of the microphone array. This means that the microphone array surrounds the thermography camera, ensuring that the thermography camera and the microphone array create a substantially identical image section of the building envelope when creating the acoustic image.

Preferably, the microphones are arranged in a circle. The circular arrangement of the microphones ensures a particularly efficient arrangement of the microphones. In order to be able to optimally calculate the mapping of the sound source on the building envelope, it is necessary to measure or estimate the distance between the measuring system and the wall. The concrete advantage of a circular arrangement is a good insensitivity to errors in the determination of the distance between the measuring system and the wall or to unevenness in the wall.

Preferably, the microphone array has more than ten and in particular more than twenty microphones.

Preferably, the microphone array has an extension of between 40 cm and 200 cm, preferably between 50 cm and 120 cm and particularly preferably between 50 cm and 100 cm. The extension defines the maximum distance between two microphones. If the microphones are arranged in a circle, the extension defines the diameter of the selected circle. The extension is an indicator of the lowest measurable frequency. The greater the extension, the lower the frequencies that can be used to localize a noise source.

Preferably, the microphones are connected to an evaluation device, wherein the evaluation device is configured to generate an acoustic image from the signals received by the microphones. For this purpose, the evaluation device can delay the acoustic signals received from the individual microphones using appropriate delay elements and then superimpose them for spatially resolved determination of the noise amplitude.

Preferably, each pixel of the thermography image is assigned a noise amplitude of the acoustic image. This makes it easy to superimpose the thermography image with the acoustic image. Alternatively, the thermography image and the acoustic image have a different resolution, wherein a mathematical assignment of the values to the locations on the building envelope is possible, for example by extrapolation or averaging.

Preferably, the thermography camera is an infrared thermography camera that ac-quires the thermography image using infrared radiation.

### BRIEF DESCRIPTION OF THE DRAWINGS

In the following, the invention is described in more detail by means of a preferred embodiment with reference to the accompanying drawings.

In the Figures:

FIG. 1 shows a schematic sequence of the method according to the present invention,

FIG. 2 shows a first embodiment of the device according to the present invention,

FIGS. 3A and 3B show a detailed illustration for acquiring the acoustic image,

FIG. 4A-4C show an illustration of the method according to the present invention, and

FIG. 5 shows measurement results according to the method of the present invention.

### DESCRIPTION OF THE INVENTION

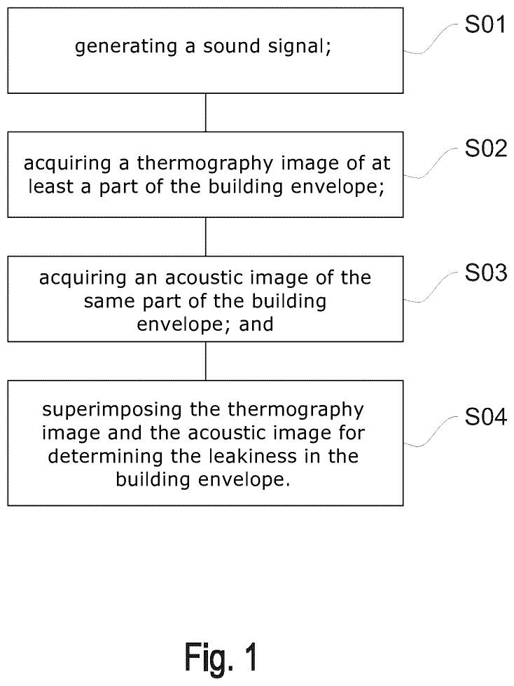

FIG. 1 shows a flow diagram according to the present invention. A sound signal is generated in step S01. Said sound signal can be generated inside the building, for example.

In step S02, a thermography image of at least a part of the building envelope is acquired.

In step S03, an acoustic image of the same part of the building envelope or at least in an overlap with the part of the building envelope acquired by the thermography image is acquired.

In step S04, the thermography image and the acoustic image are superimposed to locate the leaks in the building envelope.

Even if the acquisition of the thermography image in step S02 before the acquisition of the acoustic image in step S03 is shown in FIG. 1, the temporal sequence is not limited to this and the acquisition of the thermography image can take place after or before or simultaneously with the acquisition of the acoustic image.

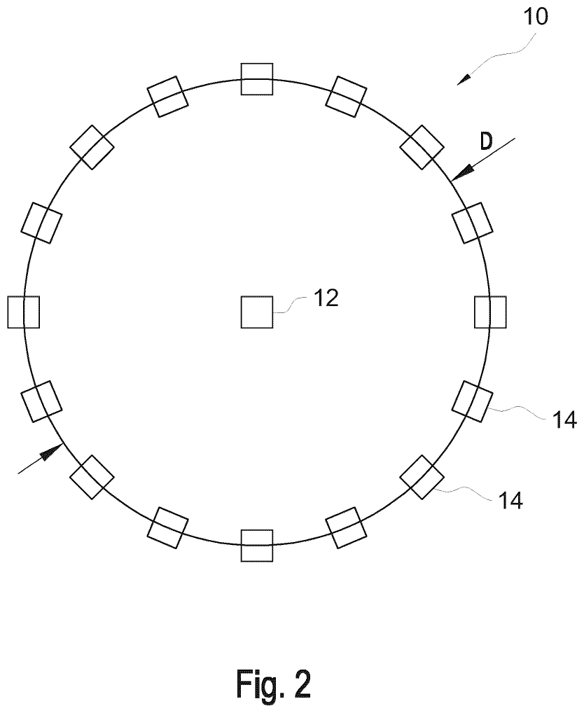

FIG. 2 shows the device according to the present invention. Device 10 has a thermography camera 12. Furthermore, device 10 has a plurality of microphones 14, which are arranged in an array. Here, the microphones 14 have a fixed and un-changeable distance to each other and to thermography camera 12. In the example of FIG. 2, the microphones 14 are arranged in a circle in the array, with thermography camera 12 arranged in the center of the microphone array. Other geometries of the array are also possible. By defining the distance between the microphones, the acoustic image can be generated. By specifying the distance between the microphone array and thermography camera 12, the superimposition of the acoustic image and the thermography image can be carried out in a simple manner and, in particular, distortion or other image errors or inaccuracies in the alignment can be avoided. In the example of FIG. 2, the circle has a diameter of between 40 cm and 200 cm and preferably between 50 cm and 120 cm. Furthermore, sixteen microphones 14 are exemplarily shown in the example of FIG. 2. Of course, device 10 may have more or fewer microphones and in particular has more than twenty and preferably more than forty microphones 14.

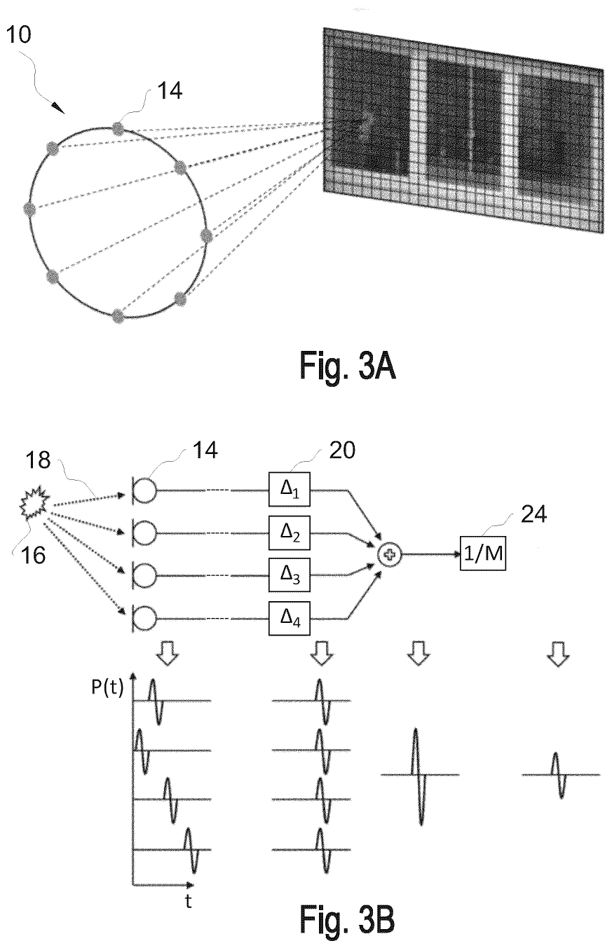

Reference is made to FIGS. 3A and 3B, which schematically illustrate the general process for creating the acoustic image. FIG. 3A shows device 10 with eight microphones 14, which detect noise amplitudes/sound amplitudes screened over a building envelope. This is schematically shown in FIG. 3B. A sound from a sound source 16 reaches the respective microphones 14 via the propagation paths 18. Here, the length of the respective propagation paths 18 differs, as a result of which the same sound from sound source 16 arrives at the respective microphones 14 at different times. This is illustrated on the bottom of FIG. 3B. Then, an evaluation device, which is connected to the microphones, has delay elements 20, by means of which the signals from the microphones 14 are suitably delayed. Here, the respective delay is changed by the delay elements 20, whereby the area of the building envelope can be screened. If the signal from the microphones 14 is superimposed due to the set delay by the delay elements 20, the location of noise source 16 is determined from the set delays and the combined signal from the respective microphones 14 is con-verted into a pixel of the acoustic image. In the following, the delays of the delay elements 20 are adjusted in such a way that the respective delays correspond to the transit times of the corresponding transmission paths 18 of the new pixel and the signals of the microphones 14 are superimposed again. This results in an acoustic image. This method is also described as beamforming.

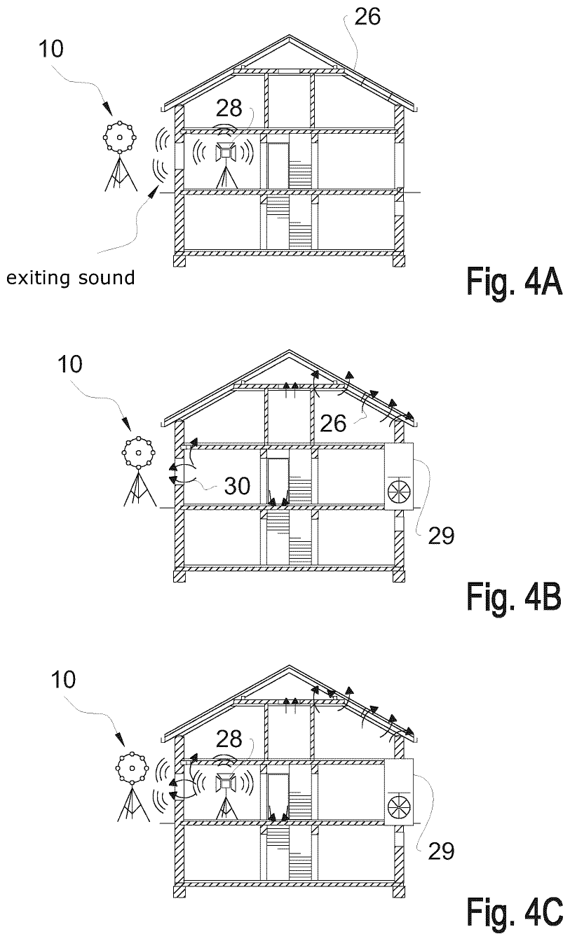

In the following, reference is made to FIG. 4A-4C . FIGS. 4A-4C show different excitation possibilities for detecting possible leakiness in the building envelope of building 26. For this purpose, device 10 is arranged outside the building. In the example of FIG. 4A, a loudspeaker 28 is set up by means of which the sound signal is generated. The sound signal is then received by device 10, making it possible to identify leakiness through which the sound waves can pass.

FIG. 4B shows an example in which positive pressure is generated in the building by means of a fan 29. Escaping air 30, which flows out through leakiness in the building envelope, generates a flow noise, which is used by device 10 to localize leakiness in the building envelope. At the same time, due to the escaping air 30, the temperature difference at the location of the leakiness can be increased if warm or cold air (depending on weather conditions or also regionally in the case of air-conditioned rooms) flows from the inside of the building through the leakiness to the outside.

The example of FIG. 4C combines the generation of the sound signal by means of a loudspeaker 28 and the generation of an overpressure in the building by means of a fan 29.

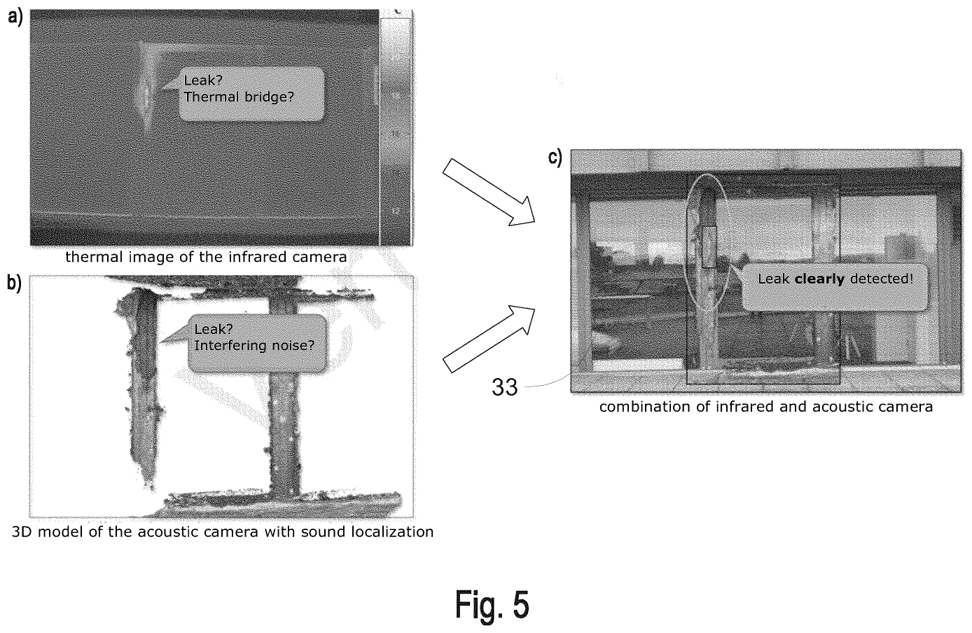

In the following, reference is made to FIG. 5. FIG. 5a shows a thermography image of a window front of a building. This results in an increased temperature difference in the area of the window frame. FIG. 5b shows an example of an acoustic image; the acoustic image also implies a leakiness in the area of the window frame. The thermography image in FIG. 5a and the acoustic image in FIG. 5b are combined so that a leak can be identified, as shown in FIG. 5c.

1. A method for determining the locations of leakiness in a building envelope of a building, comprising the steps of:
generating a sound signal;
acquiring a thermography image of at least a part of the building envelope;
acquiring an acoustic image of the same part of the building envelope by spatially resolved detection of the sound signal; and
superimposing the thermography image and the acoustic image to locate the leakiness of the building envelope.

2. The method according to claim 1, wherein the thermography image and the acoustic image are acquired from the same location or from different locations.

3. The method according to claim 1, wherein the acoustic image is acquired at different frequencies.

4. The method according to claim 3, wherein the acoustic images are superimposed at different frequencies or one or more of the acoustic images are selected.

5. The method according to claim 1, wherein the sound signal is single, periodic or continuous.

6. The method according to claim 1, wherein a loudspeaker is positioned inside or outside the building to generate the sound signal.

7. The method according to any of claim 1, wherein a positive or negative pressure is created in the building to generate the sound signal.

8. The method according to claim 1, wherein the sound signal is generated inside or outside the building and the thermography image and the acoustic image are acquired from outside or inside the building, respectively.

9. (canceled)

10. A device for acquiring a thermography image and an acoustic image for determining the locations of leakiness in a building envelope, comprising
a thermography camera for acquiring the thermography image, and
a microphone array with a plurality of microphones, the microphones being arranged at a fixed distance from one another and preferably at a fixed distance relative to the thermography camera, the acoustic image being acquired by means of the microphone array.

11. The device according to claim 10, wherein the thermography camera is arranged centrally or substantially centrally in the microphone array.

12. The device according to claim 10, wherein the microphones are arranged in a circle.

13. The device according to claim 10, wherein the microphone array comprises more than 10 and in particular more than 20 microphones.

14. The device according to a claim 10, the microphone array has an extension of between 40 cm and 200 cm, preferably between 50 cm and 120 cm and particularly preferably between 50 cm and 100 cm.

15. The device according to: claim 10, wherein the microphones are connected to an evaluation device, the evaluation device being configured to generate an acoustic image from the signals received from the individual microphones.

16. The device according to claim 1, wherein a noise amplitude of the acoustic image is assigned to each pixel of the thermography image.
